(19) United States
(12) Patent Application Publication
(10) Pub. No.: US 2021/0297159 A1
(43) Pub. Date: Sep. 23, 2021

(54) Optical Transmitter/Receiver and Method for Controlling Optical Transmitter/Receiver

(71) Applicant: Nippon Telegraph and Telephone Corporation, Tokyo (JP)

(72) Inventors: Shogo Yamanaka, Musashino-shi, Tokyo (JP); Yusuke Nasu, Musashino-shi, Tokyo (JP)

(21) Appl. No.: 17/258,392

(22) PCT Filed: Jul. 12, 2019
(86) PCT No.: PCT/JP2019/027674

§ 371 Date: Jan. 6, 2021

(30) Foreign Application Priority Data
Jul. 25, 2018 (JP) 2018-139359

(51) Int. Cl. H04B 10/40; H04B 10/516

(52) U.S. Cl. CPC H04B 10/40; H04B 10/516

(57) ABSTRACT

It is an object of the present invention to achieve an optical transceiver and a method for controlling the optical transceiver capable of reducing transmission light intensity to a sufficiently low value, when a transmission light blocking function has been started, without stopping the function of an optical receiver or without providing any variable optical attenuator. In the optical transceiver provided with a quadrature modulator in which parent and child Mach-Zehnder modulators are nested, when blocking a transmission light signal, a bias voltage of the phase modulator unit of the Mach-Zehnder modulator is adjusted so that phase differences at respective arms of the parent and child Mach-Zehnder modulators become 180 degrees.

### TECHNICAL FIELD

The present invention relates to an optical transceiver and a method for controlling the optical transceiver.

### BACKGROUND ART

Development of optical transceivers based on a digital coherent technology that combines digital signal processing and coherent wave detection is in progress. Optical transceivers to which a conventional digital coherent technology is applied have a configuration including a total of two light sources, one light source for an optical transmitter and one light source for an optical receiver. In recent years, a configuration for sharing a light source between an optical transmitter and an optical receiver has been proposed to achieve downsizing and low power consumption of optical transceivers (e.g., see Non-Patent Literature 1: FIG. 1).

### CITATION LIST

### Non-Patent Literature

Non-Patent Literature 1: Bo Zhang, Ted Schmidt, Christian Malouin, Jason O'Neil, Roberto Marcoccia, Tom Broekaert, Zbigniew Nosal and Keith Nellis “Practical Limits of Coherent Receivers for Unamplified 100 Gb/s Applications” OFC/NFOEC OW1E.3 (2013)

### SUMMARY OF THE INVENTION

### Technical Problem

Optical transceivers are required to include a function of attenuating output intensity of transmission light to less than a predetermined value (e.g., less than −30 dBm) (transmission light blocking function) as a standard function. The transmission light blocking function can be achieved, for example, by stopping continuous light output of a light source in the optical transceiver or providing the optical transmitter with a variable optical attenuator, using the variable optical attenuator to attenuate transmission light intensity when the transmission light blocking function is started.

However, when the light source is shared between the optical transmitter and the optical receiver, if continuous light output of the light source is stopped when the transmission light blocking function is started, continuous light to the optical receiver cannot be obtained, causing a problem that the optical receiver cannot be used. Providing the optical transmitter with the variable optical attenuator increases the number of parts, which is undesirable from the standpoint of downsizing of the optical transceiver.

The present invention has been implemented in view of the above problems, and it is an object of the present invention to provide an optical transceiver and a method for controlling the optical transceiver that allow, when a light source is shared between an optical transmitter and an optical receiver, the optical receiver to be used when a transmission light blocking function is started, and make it possible to attenuate transmission light intensity from the optical transmitter to a sufficiently low value without providing any variable optical attenuator.

### Means for Solving the Problem

In order to attain such an object, the present invention provides the following configuration.

(Configuration 1)

An optical transceiver including an optical transmitter including a quadrature modulator that optically modulates continuous light outputted from a light source by a transmission electric signal, the quadrature modulator including a parent Mach-Zehnder modulator provided with a child Mach-Zehnder modulator and a phase modulation unit in each of a pair of paths obtained by branching the continuous light outputted from the light source, multiplexing outputs of the pair of paths and outputting a transmission light signal, and a transmission electric circuit that applies the transmission electric signal corresponding to an input electric signal from an outside to the quadrature modulator, a control circuit that applies a bias voltage to the quadrature modulator, and an optical receiver that causes the continuous light from the light source to interfere with a received light signal from the outside, converts the signal to an electric signal and outputs the electric signal to the outside as an output electric signal, in which when blocking the transmission light signal, the transmission electric circuit stops the transmission electric signal, and the control circuit adjusts the bias voltage so that a phase difference between the continuous light passing through one path of the child Mach-Zehnder modulator and the continuous light passing through the other path becomes 180 degrees, and a phase difference between the continuous light passing through one path of the parent Mach-Zehnder modulator and the continuous light passing through the other path becomes 180 degrees.

(Configuration 2)

The optical transceiver according to the configuration 1, in which when blocking the transmission light signal, the control circuit controls the bias voltage so that light intensity detected by a light-receiving device that receives part of the transmission light signal becomes minimum.

(Configuration 3)

A method for controlling an optical transceiver including an optical transmitter in which a quadrature modulator outputs a transmission light signal, the quadrature modulator being provided with a parent Mach-Zehnder modulator constructed such that a child Mach-Zehnder modulator is nested in each of a pair of paths obtained by branching the continuous light outputted from a light source, a control circuit that applies a bias voltage to the quadrature modulator and an optical receiver that causes the continuous light from the light source to interfere with a received light signal from an outside, in which when blocking the transmission light signal, the control circuit stops a transmission electric signal, and adjusts the bias voltage so that a phase difference between the continuous light passing through one path of the child Mach-Zehnder modulator and the continuous light passing through the other path becomes 180 degrees, and a phase difference between the continuous light passing through one path of the parent Mach-Zehnder modulator and the continuous light passing through the other path becomes 180 degrees.

(Configuration 4)

The method for controlling an optical transceiver according to the configuration 3, in which when blocking the transmission light signal, the control circuit controls the bias voltage so that light intensity of a light signal obtained by branching part of the transmission light signal becomes minimum.

(Configuration 5)

The method for controlling an optical transceiver according to the configuration 4, in which control over the parent Mach-Zehnder modulator and control over the child Mach-Zehnder modulator are alternately repeated to reduce the light intensity of the transmission light signal to a sufficiently low value.

The present invention can also be said to be an optical transceiver and a method for controlling the optical transceiver, the optical transceiver being provided with a quadrature modulator constructed by nesting parent and child Mach-Zehnder modulators, in which when blocking a transmission light signal, a bias voltage of a phase modulation unit of the parent and child Mach-Zehnder modulators is adjusted so that phase differences between the respective arms of the parent and child Mach-Zehnder modulators become 180 degrees.

### Effects of the Invention

According to the present invention, it is possible to provide an optical transceiver and a method for controlling the optical transceiver capable of reducing transmission light intensity to a sufficiently low value without stopping the function of an optical receiver even when a transmission light blocking function is started or without being provided with any variable optical attenuator.

### BRIEF DESCRIPTION OF DRAWINGS

FIG. 1 is a configuration diagram illustrating an optical transceiver according to an embodiment of the present invention.

FIG. 2 is a diagram illustrating a detailed configuration of a polarization multiplexing quadrature modulator of the optical transceiver according to the embodiment of the present invention.

### DESCRIPTION OF EMBODIMENT

Hereinafter, an embodiment of the present invention will be described in detail with reference to the accompanying drawings.

### Embodiment

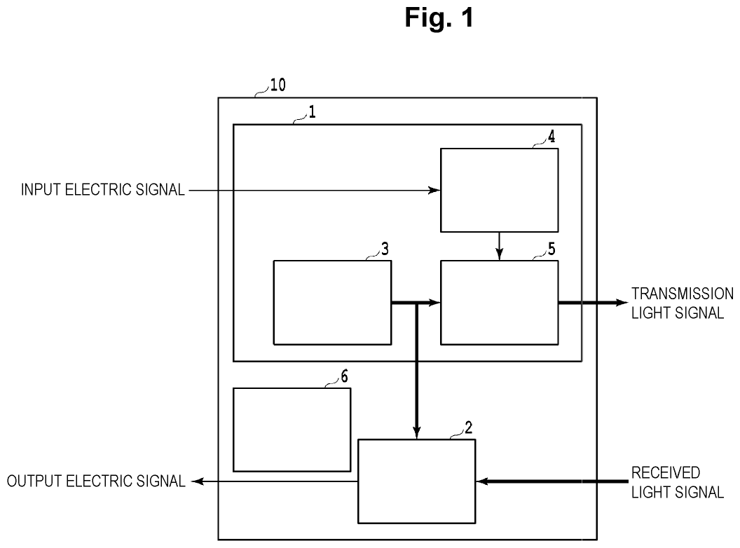

FIG. 1 is a basic configuration diagram of an optical transceiver 10 according to an embodiment of the present invention. The optical transceiver 10 is constructed of an optical transmitter 1 and an optical receiver 2. The optical transmitter 1 is constructed of a light source 3 that outputs continuous light, a transmission electric circuit 4 that converts a low-speed input electric signal to a high-speed transmission electric signal from an outside, and a polarization multiplexing quadrature modulator 5 that converts the transmission electric signal to a light signal resulting from multiplexing two polarized waves orthogonal to each other and outputs the light signal as a transmission light signal.

The optical receiver 2 causes the continuous light from the light source 3 to interfere with a received light signal, converts (demodulates) the light signal to an electric signal, compensates for distortion generated in optical fiber transmission through digital signal processing and outputs the signal to the outside as a low-speed output electric signal.

In FIG. 1, although the light source 3 is located in the optical transmitter 1, the light source 3 is shared with the optical receiver 2, and so the light source 3 may also be positioned outside the optical transmitter 1. The optical transceiver 10 also includes a control circuit 6 that monitors/controls an operating state of an element photoelectric circuit constituting the optical transceiver through a control signal from the outside.

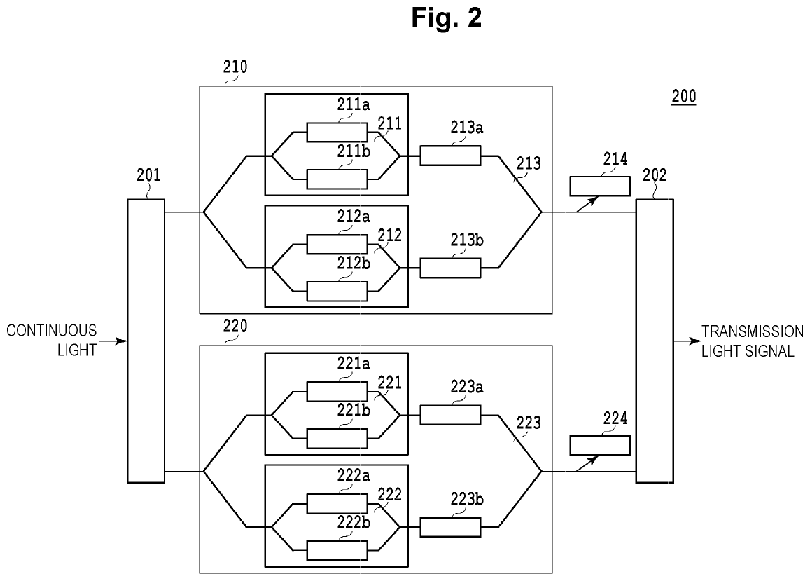

FIG. 2 is a detailed configuration diagram of a polarization multiplexing quadrature modulator 200 illustrating an example of the polarization multiplexing quadrature modulator 5 in FIG. 1. The polarization multiplexing quadrature modulator 200 is constructed of a light branching unit 201 that branches continuous light from a light source (not shown) (light source 3 in FIG. 1) for each polarized wave, a quadrature modulator 210 for X polarization and a quadrature modulator 220 for Y polarization that modulate each continuous light branched for each polarized wave, light-receiving devices 214 and 224 for branching, by several percent, transmission light signals with the modulation outputs of the respective quadrature modulators, receiving the branched modulated light, and detecting/monitoring light intensity, and a light multiplexing unit 202 that orthogonally multiplexes X polarization modulated light and Y polarization modulated light and outputs the multiplexed modulated light as a polarization multiplexed transmission light signal.

The quadrature modulators 210 and 220 in FIG. 2 are respectively constructed by nesting, as will be described later, a set of child Mach-Zehnder modulators and parent Mach-Zehnder modulators 213 and 223 provided with the sets of child Mach-Zehnder modulators in an upper path and a lower path respectively. The “sets of child Mach-Zehnder modulators” refer to a set of child Mach-Zehnder modulators 211 and 212 and a set of child Mach-Zehnder modulators 221 and 222 obtained by further branching continuous light inputted for each polarized wave in two paths (arms) and cause the lights to interfere with each other according to a phase difference between the light passing through the upper path and the light passing through the lower path. In a total of 6 sets of parent and child Mach-Zehnder modulators 211 to 213 and 221 to 223, a total of 12 phase modulation units 211a, 211b, 212a, 212b, 213a, 213b, 221a, 221b, 222a, 222b, 223a and 223b are provided in the respective upper paths and lower paths, each phase modulation unit being driven by an electric signal to change the phase of light passing through each path.

The bias voltage outputted from the control circuit 6 in FIG. 1 and the voltage of the transmission electric signal outputted from the transmission electric circuit 4 cause the phase modulation unit of each Mach-Zehnder modulator to generate a phase difference between light passing through the upper path (upper arm) and light passing through the lower path (lower arm). The continuous light is modulated by an electric signal and converted to modulated light of each polarized wave by causing lights to interfere with each other at the output unit of each Mach-Zehnder modulator according to each phase difference.

That is, the quadrature modulator 210 for X polarization and the quadrature modulator 220 for Y polarization are quadrature modulators that optically modulate continuous light outputted from the light sources by transmission electric signals respectively.

The quadrature modulator can be said to be a quadrature modulator provided with the following parent Mach-Zehnder modulator. The parent Mach-Zehnder modulator provides a child Mach-Zehnder modulator and a phase modulation unit in each of a pair of paths in which continuous light outputted from the light source is demultiplexed and made to propagate, multiplexes the output lights in the pair of paths and outputs a transmission light signal.

Here, in the pair of branched paths (arms) of the parent Mach-Zehnder modulator, the order in which the phase modulation units of the child Mach-Zehnder modulator and the parent Mach-Zehnder modulator are provided may be reversed. For example, in the case of the parent Mach-Zehnder modulator 213 of the quadrature modulator 210 for X polarization in FIG. 2, the phase modulation units 213a and 213b may be provided on the input side of the parent arm and the child Mach-Zehnder modulators 211 and 212 may be provided on the output side of the parent arm.

(Method for Controlling Optical Transceiver)

In a normal operating state (state in which the optical transmitter is in modulation operation), the control circuit 6 applies a bias voltage (Null point) at which a phase difference between the light passing through the upper path and the light passing through the lower path becomes 180 degrees to the phase modulation units of the child Mach-Zehnder modulator and applies a bias voltage (Quad point) at which a phase difference between the light passing through the upper path and the light passing through the lower path becomes 90 degrees to the phase modulation units of the parent Mach-Zehnder modulator. The transmission electric circuit 4 generates modulated light by applying a transmission electric signal to the phase modulation unit of the child Mach-Zehnder modulator centered on the Null point generated by the control circuit 6.

On the other hand, in the present invention, when the transmission light blocking function has been started, the transmission electric circuit 4 sets its output amplitude to 0 and thereby stops a transmission electric signal. Instead, the control circuit 6 may set the output amplitude of the transmission electric circuit 4 to 0.

Furthermore, the control circuit 6 applies bias voltages to the phase modulation units of the child Mach-Zehnder modulator and the parent Mach-Zehnder modulator so that a phase difference between the light passing through the upper path and the light passing through the lower path becomes 180 degrees. This is achieved by the control circuit 6 detecting and monitoring average currents outputted from the light-receiving devices 214 and 224 and controlling the bias voltages to be applied to the phase modulation units of the child Mach-Zehnder modulators 211, 212, 221 and 222, and the parent Mach-Zehnder modulators 213 and 223 so that the average currents become minimum.

The bias voltages to be applied to the phase modulation units of the respective Mach-Zehnder modulators are controlled by controlling the bias voltages in a direction in which the phase difference becomes 180 degrees for the phase modulation units to be paired for the respective Mach-Zehnder modulators, for example, the phase modulation units 211a and 211b as the pair for the child Mach-Zehnder modulator 211 and the phase modulation units 213a and 213b as the pair for the parent Mach-Zehnder modulator 213.

In a state in which the transmission light blocking function has started, since the phase difference between the light passing through the upper path and the light passing through the lower path of the child Mach-Zehnder modulator is 180 degrees, substantially no light is outputted from the child Mach-Zehnder modulator. Here, the expression “substantially no light is outputted” is used because the branching ratio of light corresponding to the upper path to light corresponding to the lower path of the Mach-Zehnder modulator is not exactly 50:50, and it is not possible to completely extinguish light even if the phase difference between the light passing through the upper path and the light passing through the lower path is 180 degrees.

The remaining light that has not been completely extinguished by the child Mach-Zehnder modulator is further extinguished by setting the phase difference between the light passing through the upper path and the light passing through the lower path of the parent Mach-Zehnder modulator to 180 degrees. Thus, transmission light intensity from the polarization multiplexing quadrature modulator is attenuated to a sufficiently low value.

Regarding the order in which a bias voltage is controlled, the parent Mach-Zehnder modulator may be controlled after controlling the child Mach-Zehnder modulator first, or reversely, the child Mach-Zehnder modulator may be controlled after controlling the parent Mach-Zehnder modulator first. Moreover, the parent and child Mach-Zehnder modulators may be alternately controlled and attenuated repeatedly so as to reduce the transmission light intensity to a sufficiently low value.

According to the optical transceiver and the method for controlling the optical transceiver of the present invention, in a state in which the transmission light blocking function has been started, by stopping the transmission electric signal of the transmission electric circuit without stopping the continuous light from the light source and setting the phase difference between light passing through the upper path and light passing through the lower path of the child Mach-Zehnder modulator and the parent Mach-Zehnder modulator to 180 degrees simultaneously it is possible to attenuate the transmission light intensity to a sufficiently low value. As a result, it is possible to reduce the output light intensity of the optical transmitter to a sufficiently low value without stopping the function of the optical receiver or without adding any light variable attenuator.

Note that although a case using a polarization multiplexing quadrature modulator has been described in the embodiment, it is obvious that the optical transceiver and the method for controlling the optical transceiver of the present invention are also applicable to quadrature modulators that are not polarization multiplexing. That is, the present invention is even applicable to a configuration of an optical modulator constructed of one quadrature modulator 210 excluding the light branching unit 201, the quadrature modulator 220 for Y polarization and the light multiplexing unit 202 as long as it is the configuration in FIG. 2.

When there is a margin in size (area) as the optical transceiver, it is possible to add and connect a variable optical attenuator to the output terminal of the above optical transceiver, further attenuate and reduce transmission light intensity in a condition in which the transmission light blocking function has been started.

### INDUSTRIAL APPLICABILITY

As described above, according to the present invention, when the light source is shared between the optical transmitter and the optical receiver, it is possible to provide an optical transceiver and a method for controlling the optical transceiver capable of using the optical receiver even when the transmission light blocking function is started, and attenuating and reducing transmission light intensity from the optical transmitter to a sufficiently low value without providing any variable optical attenuator.

### REFERENCE SIGNS LIST

10 optical transceiver
1 optical transmitter
2 optical receiver
3 light source
4 transmission electric circuit
5, 200 polarization multiplexing quadrature modulator
6 control circuit
201 light branching unit
202 light multiplexing unit
210 quadrature modulator for X polarization
220 quadrature modulator for Y polarization
214, 224 light-receiving device
211, 212, 221, 222 child Mach-Zehnder modulator
213, 223 parent Mach-Zehnder modulator
211a, 211b, 212a, 212b, 213a, 213b, 221a, 221b, 222a, 222b, 223a, 223b phase modulation unit

1. An optical transceiver comprising:
an optical transmitter comprising:
a quadrature modulator that optically modulates continuous light outputted from a light source by a transmission electric signal, the quadrature modulator comprising a parent Mach-Zehnder modulator provided with a child Mach-Zehnder modulator and a phase modulation unit in each of a pair of paths obtained by branching the continuous light outputted from the light source, multiplexing outputs of the pair of paths and outputting a transmission light signal, and
a transmission electric circuit that applies the transmission electric signal corresponding to an input electric signal from an outside to the quadrature modulator;
a control circuit that applies a bias voltage to the quadrature modulator; and
an optical receiver that causes the continuous light from the light source to interfere with a received light signal from the outside, converts the signal to an electric signal and outputs the electric signal to the outside as an output electric signal, wherein when blocking the transmission light signal, the transmission electric circuit stops the transmission electric signal, and the control circuit adjusts the bias voltage so that a phase difference between the continuous light passing through one path of the child Mach-Zehnder modulator and the continuous light passing through the other path becomes 180 degrees, and a phase difference between the continuous light passing through one path of the parent Mach-Zehnder modulator and the continuous light passing through the other path becomes 180 degrees.

2. The optical transceiver according to claim 1, wherein when blocking the transmission light signal, the control circuit controls the bias voltage so that light intensity detected by a light-receiving device that receives part of the transmission light signal becomes minimum.

3. A method for controlling an optical transceiver comprising:
an optical transmitter in which a quadrature modulator outputs a transmission light signal, the quadrature modulator being provided with a parent Mach-Zehnder modulator constructed such that a child Mach-Zehnder modulator is nested in each of a pair of paths obtained by branching the continuous light outputted from a light source;
a control circuit that applies a bias voltage to the quadrature modulator; and
an optical receiver that causes the continuous light from the light source to interfere with a received light signal from an outside, wherein
when blocking the transmission light signal, the control circuit stops a transmission electric signal, and adjusts the bias voltage so that a phase difference between the continuous light passing through one path of the child Mach-Zehnder modulator and the continuous light passing through the other path becomes 180 degrees, and a phase difference between the continuous light passing through one path of the parent Mach-Zehnder modulator and the continuous light passing through the other path becomes 180 degrees.

4. The method for controlling an optical transceiver according to claim 3, wherein when blocking the transmission light signal, the control circuit controls the bias voltage so that light intensity of a light signal obtained by branching part of the transmission light signal becomes minimum.

5. The method for controlling an optical transceiver according to claim 4, wherein control over the parent Mach-Zehnder modulator and control over the child Mach-Zehnder modulator are alternately repeated to reduce the light intensity of the transmission light signal to a sufficiently low value.
